(19) United States
(12) Patent Application Publication
(10) Pub. No.: US 2025/0368353 A1
(43) Pub. Date: Dec. 4, 2025

(54) TIRE ALIGNMENT BREAKER BAR AND YOKE

(71) Applicant: Government of the United States as represented by the Secretary of the Air Force, Wright-Patterson AFB, OH (US)

(72) Inventors: Tabitha Au, Luke AFB, AZ (US); Michael Williamson, Peoria, AZ (US)

(21) Appl. No.: 18/731,797

(22) Filed: Jun. 3, 2024

(51) Int. Cl. B64F 1/223

(52) U.S. Cl. CPC B64F 1/224

(57) ABSTRACT

A yoke and breaker bar for aligning the nose landing gear tire of an F-35 aircraft. The F-35 landing gear has a fixed forward notch which is used to align the landing gear and tire with the centerline of the airframe. The yoke is removably attached to the landing gear through a pair of matched trunnion and gudgeons. Torque may then be applied to the yoke through the breaker bar to adjust the azimuthal angle of the landing gear. An index is joined to the yoke or breaker bar for aligning the landing gear with the fixed notch. The index may be a laser beam, an elongate pointer or combination thereof.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a tire alignment tool for the nose leading gear of an F-35 aircraft and particularly to such a tool which has a visual index to assist in aligning the azimuth of the landing gear.

### BACKGROUND OF THE INVENTION

The Lockheed Martin F-35 is a single seat stealth-capable aircraft capable of carrying an ordinance payload greater than 8100 kg at supersonic speeds. The F-35 is said to be the most advanced aircraft in the world and expected to replace a host of other fighter aircraft, both domestically and internationally. Production of the F-35 airframe began Nov. 10, 2003 with the first flight completed Dec. 15, 2006. The F-35 airframe is executed in three platforms: the F-35A Lightening II designed for conventional runways and the most common platform; the F-35B Lightening II with vertical landing and short-field takeoff capability and the F-35C Lightening II built for aircraft carrier operations. All three platforms have one nose and two aft landing gear/wheel combinations.

Nine countries were involved with the development of the F-35 airframe. More than 1500 companies and 250000 jobs are involved in the supply chain and production of the F-35 airframe. Despite all of these advanced capabilities across three platforms, numerous development partners, years of production and thousands of hours of flight time, problems remain.

For example, F-35 tires are reported to last for 10 or fewer landings. It takes a four-man crew to lift an F-35 tire for service with tire weighing more than 160 pounds fully assembled. The nose landing gear must be aligned with at least with every tire change and in between after harsh landings.

These frequent nose landing gear alignments are critical for the aircraft. Particularly, the nose landing gear must be azimuthally aligned parallel to the longitudinal axis of the aircraft. Even slight misalignment can lead to mishandling, aircraft damage and even jeopardize pilot safety.

The nose landing gear alignment is determined by a rotatable collar. The collar has a notch which faces forward coincident the longitudinal axis. Currently the collar is aligned with a two leg tow bar. The two legs extend from respective proximal ends at a common hinge point to distal ends 11D remote therefrom. The distal ends 11D are disposed proximate the collar on the landing gear and the entire tow bar used to adjust the azimuthal angle. But despite years of use and refinement, problems remain. The tow bar is almost 12 feet long and weighs 100 pounds. The tow bar is difficult to use because of the size and weight, making accurate alignment of the nose landing gear more difficult to accomplish.

Furthermore, alignment requires at least a two person crew. One person of the crew is at the landing gear and visually determines the desired azimuthal angle. That person relays instructions to the remote person who manipulates the heavy tow bar back and forth as qualitatively instructed by the first crew member. But this method can lead to problems as the visual determination may be subject to parallax error and other errors.

Furthermore, due to the size and weight of the tow bar it must be hauled on a tug to various locations on the tarmac. The tug and a qualified operator may not be available, delaying necessary maintenance for aircraft at distant locations.

Accordingly, a new approach is needed which overcomes the size, weight and accuracy problems which have been present across two decades, three platforms, nine countries, 1500 companies and 250000 employees. The present invention addresses the longstanding problems and provides improved accuracy of the critical nose landing gear alignment.

### SUMMARY OF THE INVENTION

In one embodiment the invention comprises a tool for aligning a nose tire on a F-35 aircraft. The tool defines a longitudinal axis and comprises: an elongate breaker bar;

a yoke having two opposed arms extending outwardly from a common proximal end to two distal ends remote therefrom and defining a space therebetween, the yoke being joined to the breaker bar proximate the common proximal end; a trunnion juxtaposed with each distal end, each trunnion extending towards the longitudinal axis and being adapted to fit into a gudgeon of a F-35 landing gear; and an index coincident the longitudinal axis and adapted to designate the center of a notch of a collar of the F-35 landing gear. The index may comprise a laser beam, elongate pointer or both.

In one embodiment the invention comprises a method of aligning a nose tire on an F-35 aircraft having an aircraft longitudinal axis. The method comprises the steps of: providing an elongate breaker bar; a yoke having two opposed arms extending outwardly from a common proximal end to two distal ends remote therefrom and defining a space therebetween, the yoke being joined to the breaker bar proximate the common proximal end, a trunnion juxtaposed with each distal end, each trunnion extending towards the longitudinal axis and being adapted to fit into a gudgeon of a F-35 landing gear having an azimuth relative to the aircraft longitudinal axis; and an index for determining the azimuth relative to the aircraft longitudinal axis; disposing each trunnion into a respective gudgeon of the F-35 landing gear; aligning the index with a notch on a collar of the F-35 landing gear; and manipulating the breaker to adjust the azimuth of the F-35 landing gear to zero.

### BRIEF DESCRIPTION OF THE DRAWINGS

FIG. 1 is a scale perspective view of a tow bar according to the prior art with a schematic top plane view of an aircraft.

FIG. 1A is a schematic top plan view of an aircraft showing the azimuth of the nose landing gear.

FIG. 2 is a schematic, fragmentary top plan view of a tire alignment breaker bar and yoke according to the present invention in use with a collar of a landing gear.

FIG. 3A is a scale exploded perspective view of an alternative embodiment of a tire alignment breaker bar and yoke according to the present invention.

FIG. 3B is a scale side view of a yoke having a pointer offset from the plane of the yoke 3A.

FIG. 3C is a scale frontal view of the yoke of FIG. 3B.

FIG. 4A is a scale perspective view of an alternative embodiment of a tire alignment breaker bar and yoke according to the present invention.

FIG. 4B is a schematic top plan view of an alternative embodiment of a tire alignment breaker bar and yoke according to the present invention.

FIG. 5 is a schematic side elevational view of an alternative embodiment of a tire alignment breaker bar and yoke according to the present invention.

### DETAILED DESCRIPTION OF THE INVENTION

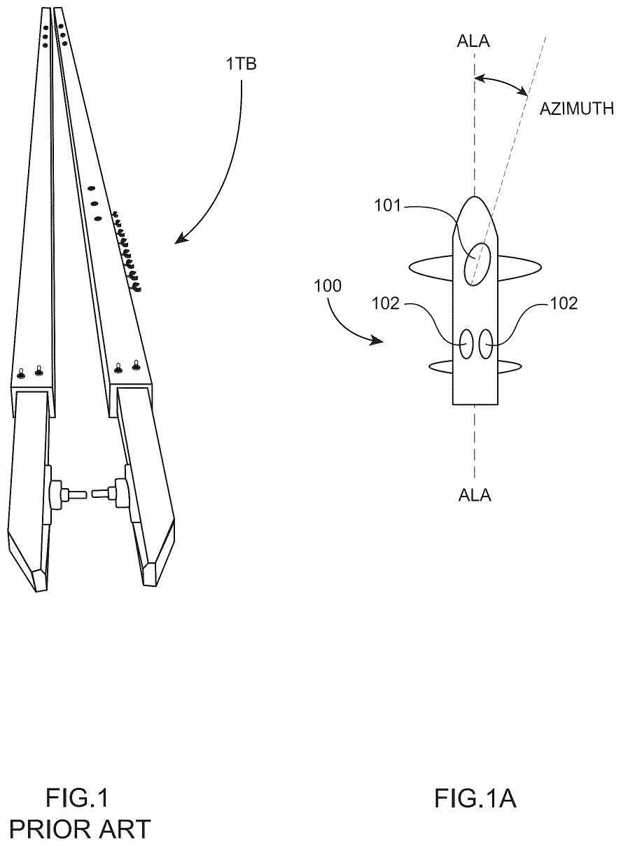

Referring to FIG. 1A, aircraft 100 have an aircraft longitudinal axis ALA. Many aircraft 100 according to the current art, such as an F-35 have a single forward nose landing gear 101 and dual aft landing gears 102. Each landing gear 101, 102 supports an associated tire. The landing gears 101, 102 must support the tire in an alignment parallel to the aircraft longitudinal axis ALA. Furthermore, the tire of the nose landing gear 101 must be coincident the aircraft longitudinal axis ALA. While the discussion below is directed to an F-35 aircraft 100, one of skill will recognize the present invention may be resized and used with any similarly appointed aircraft 100.

A discrepancy between the aircraft longitudinal axis ALA and the angle of the nose landing gear 101 tire is referred to herein as an azimuth. The azimuth is taken in the horizontal plane. The azimuth may be qualitatively determined or quantitatively determined, as designated by the has marks. Each hash mark may indicate one degree or other angular measurement as desired. When the azimuth is zero, the angle of the nose tire is properly parallel to and coincident the aircraft longitudinal axis ALA.

Referring to FIG. 1, according to the prior art a tow bar 1TB is used to maneuver the aircraft 100 from one location to another on the tarmac. The tow bar 1TB is also used to align the nose landing gear 101 in order to zero the azimuth.

The tow bar 1TB is approximately 12 feet in length and weighs approximately 100 pounds. Relocating the tow bar 1TB according to the prior art between aircraft 100 is laborious. The tow bar 1TB must be loaded onto a tug, a qualified tug operator located and the tow bar 1TB delivered to the particular aircraft 100 where needed. After maintenance on that aircraft 100, the process must be repeated for the next aircraft 100.

Furthermore, using the tow bar 1TB to align the nose landing gear 101 is also laborious. The nose landing gear 101 must be accurately aligned, to a very precise azimuthal angle. But the tow bar 1TB is heavy, making accurate alignments difficult to achieve and tiresome for the people doing the alignment.

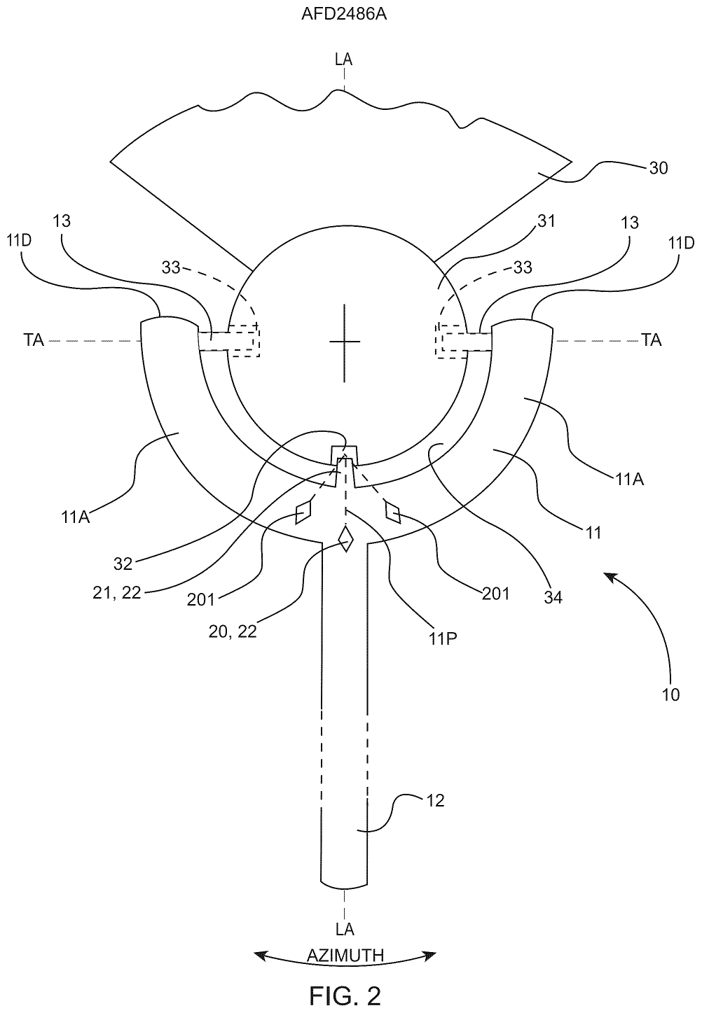

Referring to FIG. 2, the F-35 aircraft 100 has a collar 31 at the forward position of the nose landing gear 101 and which is held in static position by a portion of the landing gear frame 30. The collar 31 has a notch 32 at the forward position of the collar 31. The notch 32 designates the aircraft longitudinal axis ALA and is coincident the centerline of the aircraft 100. The notch 32 is the benchmark for determining azimuthal alignment of the landing gear 101 relative to the aircraft longitudinal axis ALA.

The landing gear frame 30 also has two opposed gudgeons 33. The gudgeons 33 are perpendicular to the aircraft longitudinal axis ALA and disposed in a different horizontal plane than the notch 32.

A tool 10 according to the present invention has a longitudinal axis LA and is preferably symmetric about the longitudinal axis LA which is the longitudinal centerline of the yoke 11. The tool 10 has three major components, a yoke 11 for attaching to the landing gear 101, a breaker bar 12 joined thereto and functioning as a handle and an index 22 for determining the azimuth.

Examining the invention in more detail, the yoke 11 has two opposed arms 11A. The two opposed arms 11A extend outwardly from a common proximal end 11P disposed on the longitudinal axis LA to mutually opposed distal ends 11D spaced outwardly of the longitudinal axis LA. The yoke 11 may be generally planar and may be disposed in a generally horizontal position during use. In use there may be a space 34, particularly a semi-annular space 34 between the arms 11A of the yoke 11 and the landing gear 101.

Each arm 11A of the yoke 11 has a trunnion 13 juxtaposed with a respective distal end 11D of that arm. The trunnions 13 extend inwardly towards the longitudinal axis LA. The opposed trunnions 13 are sized and spaced to fit into the gudgeons 33 of the landing gear 101. The trunnions 13 may be generally cylindrically shaped with a round cross section. A transverse axis TA connects the centers of the round trunnions 13. The transverse axis TA is perpendicular to the longitudinal axis LA and lies in the same plane. The trunnions 13 apply torque to the landing gear 101 and tire to adjust, minimize and eliminate the azimuth.

The breaker bar 12 may be removably or fixedly joined to the yoke 11 and particularly at the common proximal end 11P of the yoke 11 arms 11A. The breaker bar 12 is coincident the longitudinal axis LA and functions as a handle for manipulation of the tool 10 by a user.

The index 22 is parallel to and preferably disposed on the longitudinal axis LA. The index 22 is sued to align the notch 32 with the longitudinal axis LA, thereby reducing the azimuth to zero. The index 22 may be fixedly joined to the yoke 11 or breaker bar 12. This arrangement provides the benefit of minimizing calibration. Or the index 22 may be adjustably joined to the yoke 11 or breaker bar 12. This arrangement provides the benefit of minimizing ensuring accuracy when the index 22 is subject to rough handling or misuse.

In one embodiment the index 22 may comprise a pointer 21 which extends towards and optionally into the notch 32. The pointer 21 is coincident and parallel to the longitudinal axis LA. The pointer 21 may lie in the same plane as the longitudinal axis LA and the transverse axis TA. The pointer 21 may be removably attached to the yoke 11 or may be integral therewith. In one particular embodiment the pointer 21 extends outwardly from the proximal end 11P of the arms 11A of the yoke 11. This embodiment provides the benefit that there are no moving parts or replaceable parts.

In another embodiment the index 22 may further comprise a level 23. The laser 20 is coincident and parallel to the longitudinal axis LA. The laser 20 may lie in the same plane as the longitudinal axis LA and the transverse axis TA. In one particular embodiment the laser 20 beam shines outwardly from the proximal end 11P of the arms 11A of the yoke 11, providing extended distance to the notch 32.

The laser 20 may be a single visible beam and may optionally provide a quantitative measurement of the distance from the respective position on the yoke 11 to the back of the notch 32. A DWHT77100 laser distance measurer available from DeWalt Too Co. of Towson, MD, a REVBDILL 100 cordless line laser level available from Stanley Black & Decker, Inc. of New Britain, CT or a 417D laser distance meter available from Fluke Corp. of Everett, WA may be suitable. Alternatively the laser 20 may display one plane or more planes which intersect at the center of the notch 32. A621CG Self-leveling green laser level cross line available from Huepar of Zhuhai City, China may be suitable. This embodiment provides the benefit that there are no moving parts or replaceable parts.

In an alternative embodiment, instead of or in addition to a single laser 20 coincident the longitudinal axis LA the yoke 11 may have one or more laser 201 offset from the longitudinal axis LA. For example two offset and symmetrically opposed lasers 201 may be used, with one offset laser 201 disposed 45 degrees out on each side of the longitudinal axis LA. This arrangement prophetically provides the benefit of more accurate alignment with the notch 32. Additionally a pointer 21 may be used in conjunction with the lasers 20, 201.

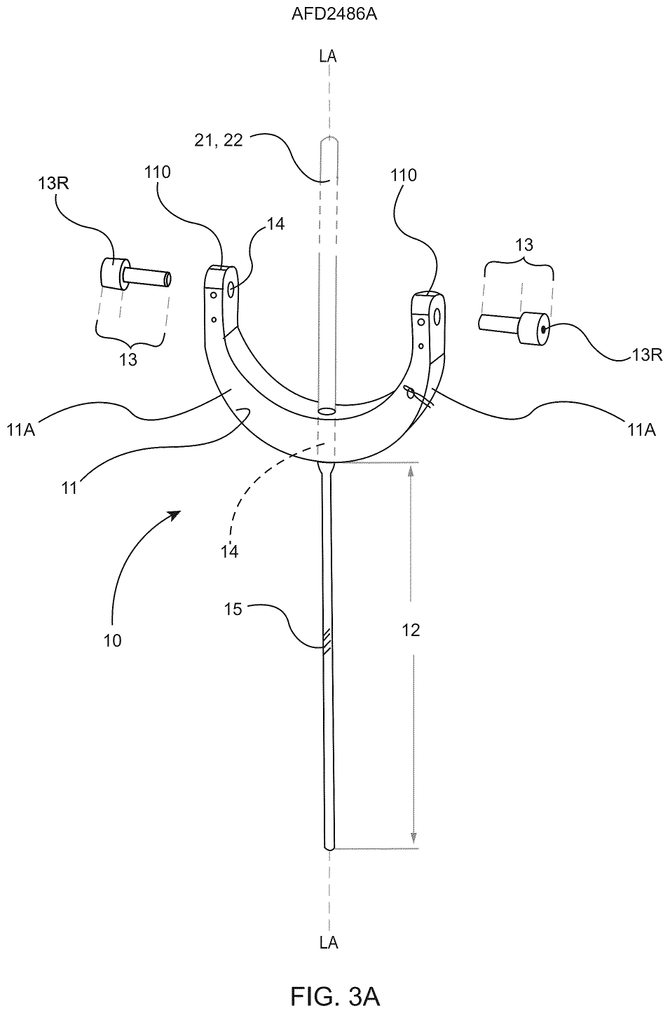

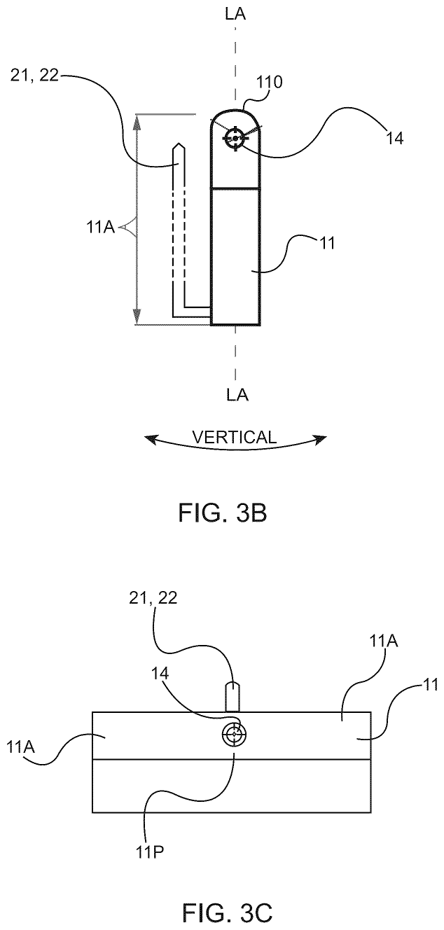

Referring to FIG. 3A, FIG. 3B and FIG. 3C, in one embodiment a pointer 21 type of index 22 may be integral with the breaker bar 12. As the pointer 21 is inserted into the notch 32, the pointer 21 and breaker bar 12 are withdrawn in the direction of the arrow through a hole 14 in the yoke 11. This arrangement provides the benefit that full engagement of the pointer 21 into the notch 32 is easier to accomplish, improving minimization and elimination of the azimuth. If desired the breaker bar 12 may have attachment threads 15 to provide for disassembly during storage and reassembly during use.

The trunnions 13 may be inserted from outside the yoke 11 towards the longitudinal axis LA. The trunnions 13 may have a shank 13S which intercepts the gudgeon 33 of the landing gear 101. The trunnions 13 may have a shoulder 13R which is enlarged relative to the shank 13S to limited insertion and assist in rigidly holding the trunnion 13 in place.

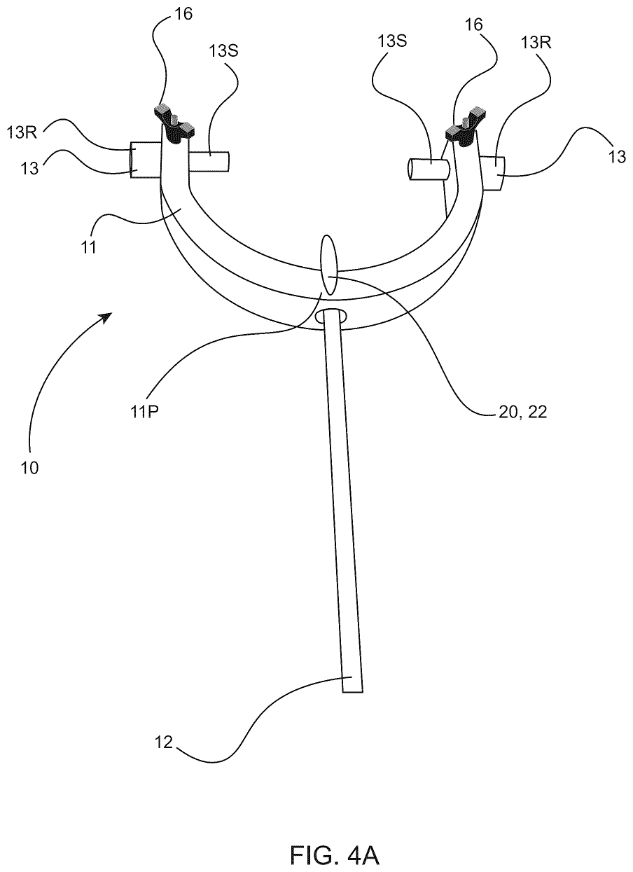

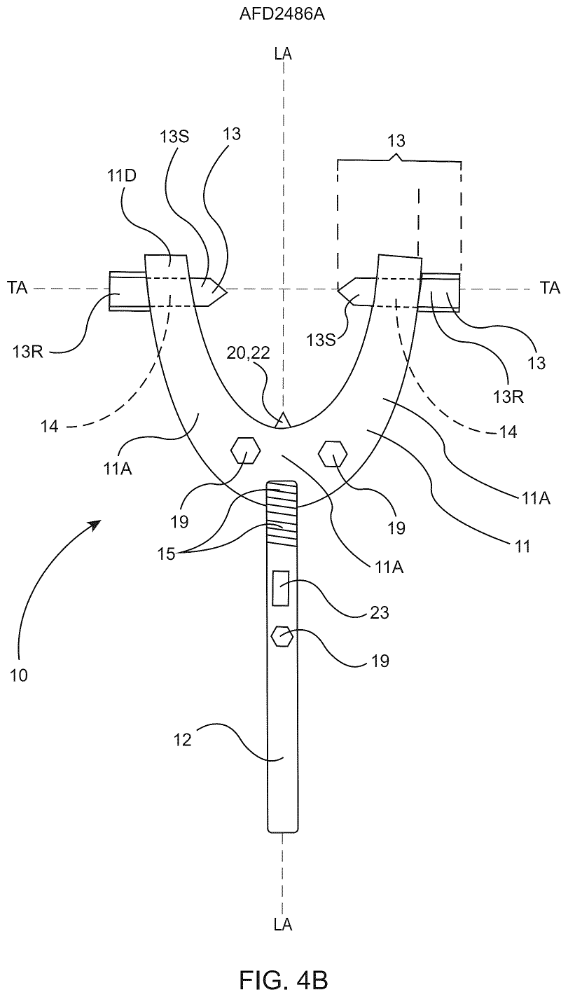

Referring to FIG. 4A, each trunnion 13 may be held in place with a respective retaining pin 16. This arrangement provides the benefit that the trunnion 13 may be removed for storage and reinserted and held in place during use. The retaining pin 16 is then inserted perpendicular to the transverse axis TA to hold the retaining pin 16 in place. A T-Handler Locking quick Release Pin available from McMaster-Carr of Elmhurst, IL is believed to be suitable.

Referring to FIG. 4B, the yoke 11 may taper from the proximal end 11P to the respective distal ends 11D. This arrangement conserves weight and material where less stress occurs as the distal ends 11D are approached. If desired, the breaker bar 12 may be threadably attached to the yoke 11. This arrangement provides for disassembly during storage and reassembly for use.

The trunnion 13 may be threadbly inserted into a respective internally threaded hole 14 in the arm 11A of the yoke 11. Alternatively or additionally, an externally threaded trunnion 13 may be held in place with a jam nut. The distal ends 11D of the trunnions 13 may be pointed, to allow for easier insertion into the gudgeon 33 in the event of slight misalignment.

The breaker bar 12 and/or yoke 11 may have indicia 19. The indica may provide instructions for use, inventory data, safety information, etc.

The yoke 11 or breaker bar 12 may have a level 23. The level 23 assists in holding the breaker bar 12 and yoke 11 generally horizontal during use, minimizing the chance of parallax error. The level 23 may be any of the common bubble levels 23 as are commercially available. Or a laser level 23 may be used, as described above.

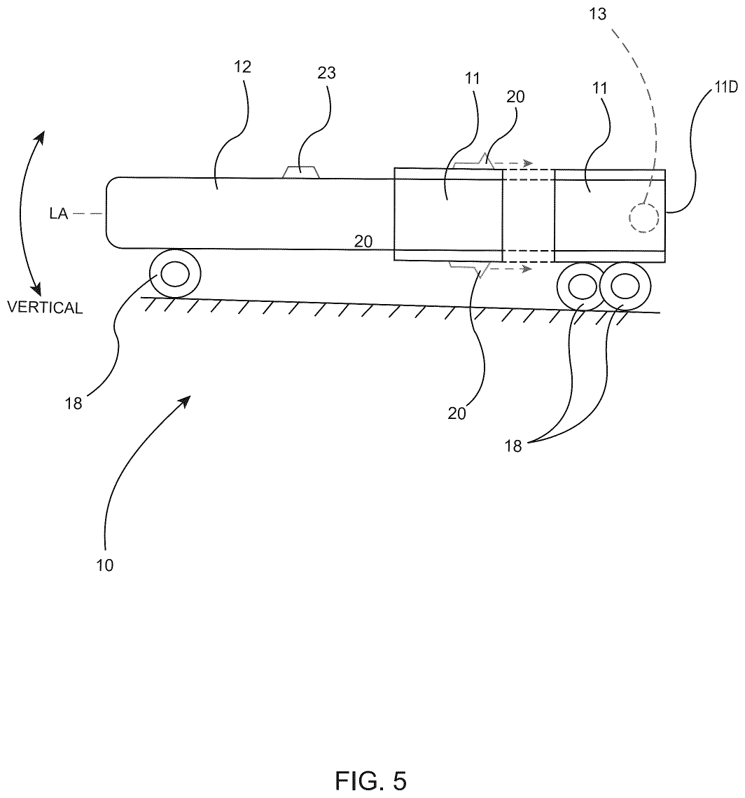

Referring to FIG. 5, the yoke 11 and/or handle may have castors 18 to assist with mobility and relive the operators from carrying the weight. If desired, dual lasers 20 may be used to improve alignment in the respective plane and provide for insertion of the pointer 21 at two different elevations, as needed.

In use a person wishing to align a nose tire on an F-35 aircraft 100 is provided with the breaker bar 12, yoke 11 and index 22 of the present invention. A person disposes each trunnion 13 into a respective gudgeon 33 of the F-35 landing gear 101 and aligns the index 22 with a notch 32 on a collar 31 of the F-35 landing gear 101. A person then azimuthally manipulates the breaker to adjust the azimuth of the F-35 landing gear 101 to zero. The determination of the azimuth may be qualitative or quantitative.

A benefit of the present invention is that only a single person may be necessary for the F-35 tire alignment. Alternatively, a first person may be proximate the collar 31 of the landing gear 101 to determine whether or not the azimuth is coincident the aircraft 100 longitudinal centerline or left/right relative thereto. A second person manipulates the breaker bar 12 in response to commands of the first person to adjust, minimize and eliminate the azimuth.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A tool for aligning a nose tire on a F-35 aircraft, the tool defining a longitudinal axis and comprising:
an elongate breaker bar;
a yoke having two opposed arms extending outwardly from a common proximal end to two distal ends remote therefrom and defining a space therebetween, the yoke being joined to the breaker bar proximate the common proximal end;
a trunnion juxtaposed with each distal end, each trunnion extending towards the longitudinal axis and being adapted to fit into a gudgeon of a F-35 landing gear; and
an index coincident the longitudinal axis and adapted to designate the center of a notch of a collar of the F-35 landing gear.

2. A tool according to claim 1 wherein the index comprises a laser oriented towards the space between the opposed arms.

3. A tool according to claim 2 wherein the laser is disposed on the longitudinal axis, mounted to the yoke and juxtaposed with the common proximal end of the arms.

4. A tool according to claim 3 wherein the laser is fixedly mounted to the yoke.

5. A tool according to claim 3 wherein the laser is adjustably mounted to the yoke.

6. A tool according to claim 2 wherein the laser is disposed on the longitudinal axis, and mounted to the breaker bar.

7. A tool according to claim 6 wherein the laser is removably mounted to the breaker bar.

8. A tool according to claim 2 further comprising a level in combination with the laser.

9. A tool for aligning a nose tire on a F-35 aircraft, the tool defining a longitudinal axis and comprising:
an elongate breaker bar;
a yoke having two planar and opposed arms outwardly cantilevered from a common proximal end to two distal ends remote therefrom and defining a generally planar space therebetween, the yoke being joined to the breaker bar proximate the common proximal end,
a trunnion juxtaposed with each distal end, each trunnion extending towards the longitudinal axis and being adapted to fit into a gudgeon of a F-35 landing gear; and
an index coincident the longitudinal axis and adapted to designate the center of a notch of a collar of the F-35 landing gear.

10. A tool according to claim 9 wherein the index comprises an elongate pointer coincident the longitudinal axis and oriented towards the space between the opposed arms.

11. A tool according to claim 10 wherein the pointer is coincident the plane of the arms of the yoke.

12. A tool according to claim 9 wherein the pointer is coincident the plane of the arms of the yoke.

13. A tool according to A tool according to claim 9 wherein the pointer is joined to the yoke proximate the common proximal end of the arms and extends away therefrom to a distal end. The distal end of the pointer being spaced away from the plane of the arms.

14. A method of aligning a nose tire on an F-35 aircraft having an aircraft longitudinal axis, the method comprising the steps of:
providing an elongate breaker bar; a yoke having two opposed arms extending outwardly from a common proximal end to two distal ends remote therefrom and defining a space therebetween, the yoke being joined to the breaker bar proximate the common proximal end, a trunnion juxtaposed with each distal end, each trunnion extending towards the longitudinal axis and being adapted to fit into a gudgeon of a F-35 landing gear having an azimuth relative to the aircraft longitudinal axis; and an index for determining the azimuth relative to the aircraft longitudinal axis;
disposing each trunnion into a respective gudgeon of the F-35 landing gear;
aligning the index with a notch on a collar of the F-35 landing gear; and
manipulating the breaker to adjust the azimuth of the F-35 landing gear to zero.

15. A method according to claim 14 wherein the step of disposing each trunnion into a respective gudgeon further comprises the step of locking each trunnion into place using a retaining pin.

16. A method according to claim 14 wherein the step of manipulating the breaker bar comprises qualitatively determining whether or not the azimuth is zero.

17. A method according to claim 16 having a first person proximate the collar of the landing gear to determine whether or not the azimuth is coincident the aircraft longitudinal centerline or left/right relative thereto.

18. A method according to claim 17 wherein the first person determines qualitatively determines the azimuth using a laser mounted on the yoke.

19. A method according to claim 17 wherein the first person determines qualitatively determines the azimuth using an elongate pointer mounted on the yoke.

20. A method according to claim 17 further comprising the step of providing a second person who manipulates the breaker bar responsive to commands from the first person.
